(19) United States
(12) Patent Application Publication
(10) Pub. No.: US 2004/0017018 A1
(43) Pub. Date: Jan. 29, 2004

(54) Method and facility for producing micromembrane capsules

(76) Inventor: Rainer Pommersheim, Mainz (DE)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/258,752

(22) PCT Filed: Apr. 25, 2001
(86) PCT No.: PCT/EP01/04684

(30) Foreign Application Priority Data
Apr. 28, 2000 (DE) 100 20 889.4

(51) Int. Cl. B01J 13/02; B01J 13/22

(52) U.S. Cl. 264/4.3; 425/5

(57) ABSTRACT

The invention relates to a method and facility for industrial scale production of micromembrane capsules for immobilizing active ingredients, proteins, live cells and/or microorganisms. According to the invention, the material dissolved in a base material or in suspended form that is to be encapsulated is fed from a reservoir into a reactor, wherein drops are produced from said material and balls are formed by precipitating said drops. The balls enclose the material and are then in turn coated by repeated rinsing in the same and/or different vessel.

The invention relates to a method and to a facility for producing micromembrane capsules in industrial scale, for use in food technology, biotechnology, chemical and/or pharmaceutical industry, as well as medicine. Such types of capsules consist of a preferably spherical core, which contains the immobilized material or living cells or microorganisms and which may be enclosed by a capsule that completely encompasses this core.

In technological applications as well as in medicine, it is often necessary to immobilize materials as well as living cells. In this manner, their handling may be improved, which results in a great reduction in costs. Sometimes however, it is also the only way to be able to use certain active ingredients or living cells. Microcapsuling is a known method for this.

To be able to encapsulate cells, enzyme, or other substances, they are added to a liquid, often water-soluble basic substance, which is then converted to droplets through suitable devices. The drops formed are precipitation-hardened and contain substance dissolved or suspended therein or the cells. This may be done either through an interlacing in a precipitation bath or by changing physical parameters, such as temperature, for instance. The globules formed in such a manner, whose diameter lies in a range of a few micrometres to a few millimetres, may subsequently be coated.

In technical literature, methods have been described that use microorganisms immobilized in globules, such as yeast, for instance. Thus, G. Troost et. al., for instance (G. Troost et. al., Champagne, sparkling wine, petulant wine, Stuttgart 1995), describes yeast immobilized in alginate balls for bottle fermentation in sparkling wine production. As a result, the time-consuming manual shaking off of the yeast deposit may be replaced by the speedy sinking of the globules in the champagne bottle. The disadvantage of these immobilisates is, however, the fact that the yeast cannot always be prevented from growing out of the globules.

In the German published patent application DE 3836894 A1, a method as well as a device is described, which may be used for the production of such types of alginate globules. Here, a suspension is formed from the microorganisms to be immobilized and the alginate element, which is subsequently dripped into a precipitation bath. This takes place through capillaries that are oscillated. Although the method illustrated here may also be used to produce greater quantities of capsules, the immobilisates obtained are not suited for occluding chemical substances because of the lack of an additional capsule membrane. Germination of the cells from the capsules also cannot be prevented. The PCT application PCT/CH96/00097 describes a similar method for producing microcapsules, which in contrast to the above-mentioned production process facilitates a preparation of the globules under sterile conditions, i.e., mainly supplies capsules for the medical field. The immobilisates obtained with the device described here exhibit the same defects as the above method, however. Even here, the growing of the cells may not be ensured and chemical compounds, such as proteins (enzyme), for example, may not be held in the capsules.

In “Science; Volume 210, pages 908-910; year 1980, F. Lim and A. Sun describe a capsule with a semi-permeable membrane for immobilizing living cells in the capsule core, which is surrounded by a single layer of a ply 1-lysine/alginate complex. In these capsules, the cells are prevented from coming out of the capsule core. Because of their relatively slight mechanical stability, this membrane capsule is not suitable for use in technical processes. No molecules the size of an enzyme or smaller may be included therein, since the membrane is permeable for this.

In Patent Specification P 43 12 970.6, a membrane capsule is described that is suitable for immobilizing enzymes and proteins, as well as living cells. Here, the core containing the immobilisate is covered with a multilayered cover, in which each of these layers imparts a certain property to the entire capsule. Through the advantageous selection of the capsule polymers, the permeability of the membrane may be reduced in such a way that even enzymes remain in the capsule, while the much smaller substrates and products may pass the membrane. These capsules could heretofore only be produced in a laboratory scale, i.e., in small quantities.

Departing from the known prior art, the invention is based on the task of creating a method as well as a corresponding facility that for the first time facilitates the production of micromembrane capsules in big, i.e., large-scale, quantities.

The solution to the task of the invention is in a method according to Patent claim 1 as well as a facility according to Patent claim 26.

The production process according to the invention is structured accordingly in two sections, namely the design and the coating.

During the design, the material to be encapsulated is suspended or dissolved in a basic material solution, preferably sodium alginate. This basic material suspension or solution is afterwards transported through a suitable device to a coating reactor. This may be done through compressed air, although pumps, screw conveyers, etc., may also be used. From this suspension or solution, globules may then be formed through dripping into a precipitation bath. This may follow either through complexing with a multivalent salt solution, as in the case of the alginate, or through the change of physical parameters, such as temperature. When immersed into the precipitation bath, the liquid drops then become gel and enclose the material to be encapsulated.

Depending on the desired size, productivity, and size distribution, several methods may be used for converting the liquid into droplets. Thus, capillaries may be used, in which the drop is torn off through an air current, as described by F. Lim and A. Sun in Science; Volume 210, pages 908-910, year 1980. Capsule sizes between approximately 200 μm and approximately 2 mm with a very narrow size distribution are obtained in such a manner. In order to ensure sufficient productivity, several nozzles are arranged on a nozzle plate incorporated into the reactor.

A further useful method for droplet formation is that which is described in Patent Application DE 3836894. Here, several capillaries are oscillated, resulting in a separation of the liquid streams into individual drops. Such types of nozzle plates may be built into the reactor. The capsules obtained here also have diameters of between approximately 200 μm and approximately 2 mm, in which the productivity is much higher than for the above-mentioned nozzles, but for a much wider-scale distribution.

Very small particles, in the range of approximately 20 μm to approximately 200 μm, are obtained by spinning on a rotary table. However, in the design of the reactor, the flight cone¹ of the drops must be taken into account so that these may reach the precipitation bath and not get stuck on the walls.

¹Translator's note: The term “Flugkegel” could not be found in standard references. “Flight cone” is a literal translation of the individual terms “Flug” and “Kegel”.

The coating of the gel particles formed in such a manner takes place by immersing them in the respective coating solutions. These are diluted, watery solutions of polymers with anionic or cationic groups, such as, for example, chitosan, polyvinyl. pyrrolydon, polyethylenimine, carbocymethyl cellulose, alginate, polyacrylic acid, etc., which form so-called polyelectrolyte complex coatings on the capsule surface. Through repeated immersion of the particles in these solutions, several coatings of the capsule covering are formed. In order to prevent the globules from sticking together during the coating, thereby guaranteeing optimal membrane formation, these must be kept in suspense. This may take place according to the invention by stirring with special agitating machines, or the so-called visco-jet mixers, although the coating reagents may also be introduced into the reactor tangentially at high speed, so that similar to a hydrocyclone, a movement of the liquid is reached, which swirls the capsules. In addition, washing may take place in between with a suitable detergent. The necessary coating or washing solutions are found in feeding basins and may be available either ready-made or as a concentrate. The manufacturing process runs at approx. 25° C. and atmospheric pressure. Nevertheless, a temperature equalization capability for the reactors may be provided in order to be able to heat up the liquids to up to approx. 65° C., if needed, or to be able to cool them down to approx. 5° C.

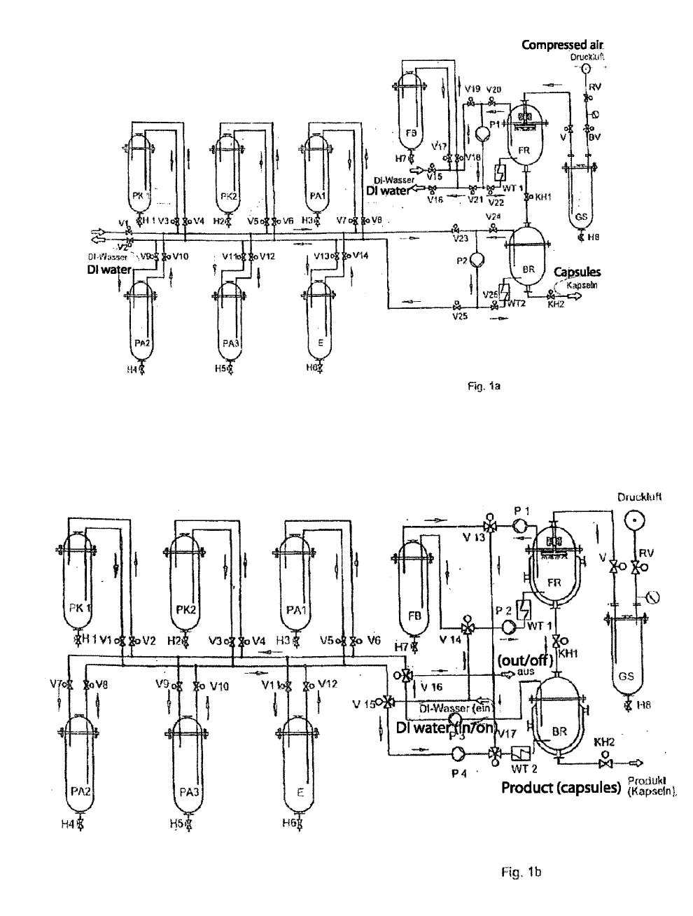

FIGS. 1a; 1b; 2a; 2b; 3a; and 3c show several embodiments of the method as well as the corresponding facilities for large-scale production of membrane capsules.

In the facilities shown in FIGS. 1a and 1b, all solutions are ready-made in the reservoirs, i.e., in diluted form. Two separate reactors are used for processing, one for the shaping and another for the coating.

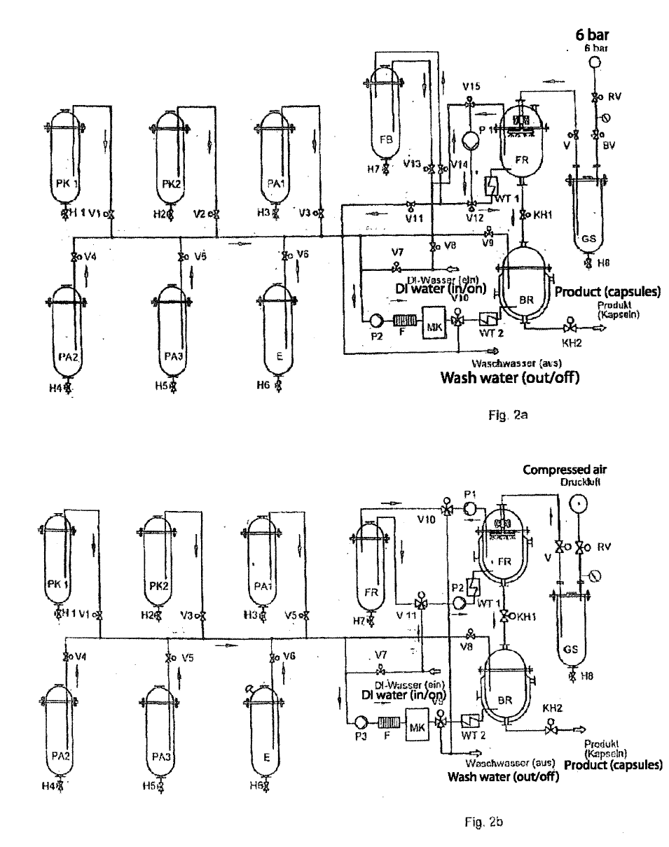

In the facilities of FIGS. 2a and 2b., which likewise have two reactors, only the precipitation reagent is stored in diluted form, while the coating reagents are present as concentrates, which are subsequently diluted.

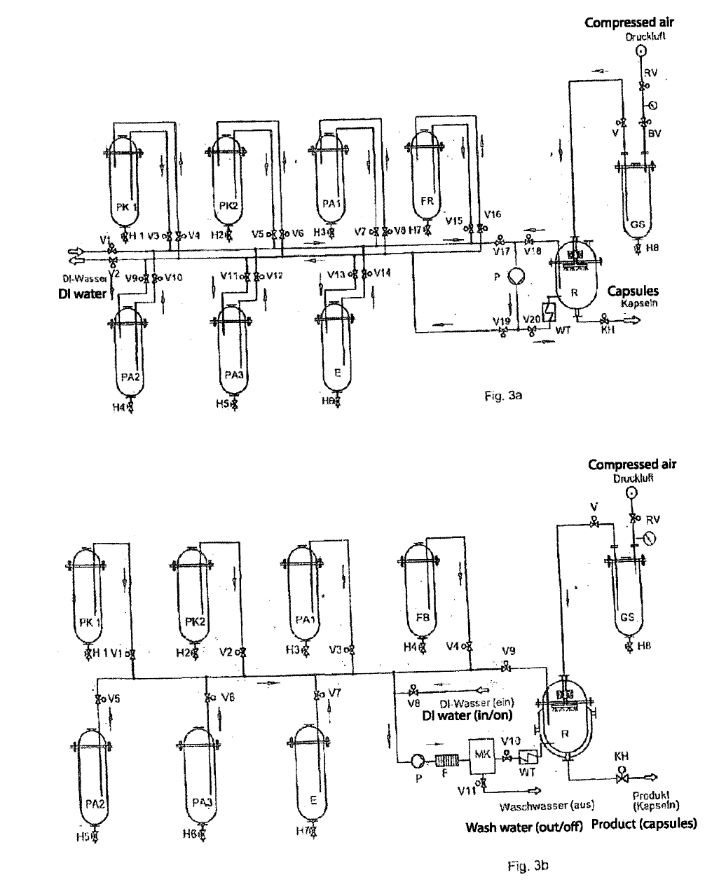

FIGS. 3a and 3b show facility variations that work only with a reactor and in which, as shown in FIG. 3b, all reagents used in the process may first be present as concentrates.

Of course, further variations are conceivable, which consist of combinations of the facility diagrams illustrated in the drawings.

The embodiments with two reactors are characterized by a higher productivity since the coating of the globules may be carried out while the conversion of the liquid into droplets, i.e., the shaping, continues.

The variants with a reactor consequently have a lower productivity, but are simpler and, from the perspective of equipment, cheaper to execute.

In all the embodiments described, a suspension is first prepared from the material to be encapsulated and base material solution and filled into the GS pressure vessel. By opening from the valve RV, the vessel is impinged on with pressure (approximately 8-10 bar), by which the suspension is pressed through the opened valve V into the corresponding reactor. This may be FR or R, depending on the facility. Through an additional valve BV, which is indicated in some embodiments according to the invention, the vessel GS may also be ventilated. The transport of the liquid by means of compressed air is necessary so that no damage may occur on the material to be encapsulated. However, other gentle facilities, such as suitable pumps or conveyor worms, may be used.

In the corresponding reactor (FR or R), the suspension is separated into individual drops through a suitable device. Through the precipitation reagent into which the drops fall, they gel into gel particles. The size of the particles that arise depends on the droplet conversion process used. The volume flow of the base material suspension is regulated through RV.

Depending on the variant of execution, the precipitation reagent may reach the FR or R reactor from the supply vessel FB in different ways. Since the introduction of the liquid in all cases takes place tangentially, the gel particles are swirled so that additional stirring may be dispensed with. The suction pipe must be provided with a filter so that no capsules are suctioned along. A temperature equalization of the solutions may take place by means of the heat exchanger WT1 or WT.

In the embodiment illustrated in FIG. 1a, the precipitation reagent is transported by opening the valve V17, V19, and V22, and by pumping through the pump P1 into the shaping reactor FR. After reaching an appropriate level in FR, V17 and V19 is closed and V20 is opened, by which the solution is circulated in the circle. After the gel particles formed have spent a few minutes of hardening time in the precipitation bath, the solution is pumped back by closing V22 and by opening V21 and V18 after FB. Afterwards, by closing V18 and V21 and by opening V15, V19, and V22, the globules are washed with DI water, which similar to the precipitation reagent, is first put into circulation through an analog valve setting and then is partially pumped out again by closing V22 and opening V21 and V16. The gel particles formed are subsequently transported into the coating reactor BR as watery suspension by opening the ball valve KH1 by gravitational force.

In the embodiment according to the invention illustrated in FIG. 2a, this procedural step takes place similarly to that in 1a, although the 2-way valves V19 and V20 or V21 and V22 from 1a were replaced by appropriately arranged 3-way valves V15 or V12. V17 and V18 or V15 and V16 from 1a correspond here to valves V13 and V14 or V8 and V11.

Likewise similar to the facility illustrated in variant 1a, this first procedural step runs according to the invention in the embodiment illustrated in FIG. 3a. V15 and V16; V17 and V18; V19 and V20; V21 and V22 from the facility illustrated in 1a correspond here to valve pairs V1 and V2; V15 and V16; V17 and V18; V19 and V20. Since the variant in FIG. 3a works with a single reaction vessel R, the flushing of the capsules into the coating reactor is omitted here. The wash water is completely pumped out here after the gel balls have hardened since the coating is carried out in the same vessel.

In the variants illustrated in FIGS. 1b and FIG. 2b, thanks to the existence of two pumps (P1 and P2), the precipitation reagent may be always be pumped back anew from the reservoir FB to the reactor FR and then back to FB during the entire first procedural step when the valves V13 and V14 in FIG. 1b or V10 and V11 in FIG. 2b are in the appropriate position. Since the precipitation bath in FR is constantly renewed in this manner, the concentration of active ingredient in the precipitation bath remains almost constant during this entire initial procedural step. After a few minutes of hardening time, in the illustrated variants as well, the globules are washed with DI water by turning the valves V13 and V14 (FIG. 1b) or V10 and V11 (FIG. 2b), in the course of which the reaction vessel, thanks to the two pumps P1 and P2, can always be provided with new water and need not be put into circulation as in the variants illustrated in FIGS. 1a, 2a, and 3a.

The embodiment variation illustrated in FIG. 3b do not work with ready-made solutions but rather with concentrates that must first be diluted. For this purpose, before the start of the dripping through the valve V8, the filter F, and the valve V10, DI water is guided into the reaction vessel R by means of the pump P via the mixing chamber MK and the heat exchanger WT.

The V8 is closed and V9 is opened at an appropriate level so that the water circulates in the cycle. Afterwards, through V4, the quantity corresponding to the desired concentration is added from FB to the concentrate. Afterwards, the suspension in the reaction vessel R is converted into droplets from GS. As already described in the embodiment illustrated in FIG. 3a, the globules also remain here in Reactor R after their hardening.

After the globules have hardened, the second procedural step, the coating, takes place. In all embodiments according to the invention, this happens by rinsing the capsules alternately with a cationic and an anionic, diluted polymer solution. Washing steps are provided in between. The particles are each exposed for a few minutes to the solutions, which may again be pumped back into the reservoirs. The important thing is that during the entire process, the capsules are kept in suspense in a type of fixed bed so that the membrane may form all around. This may be done by means of special agitating machines, or as drawn in the present embodiments, through tangential passing of the solutions. at relatively high speed, which should amount to several meters per second at the pipe outlet. The liquids may be temperature-equalized through the corresponding heat exchanger WT2 or WT. After coating is completed, the finished membrane capsules are washed and rinsed out of the reaction vessel. A drying step may subsequently follow, whereby the water is withdrawn from the capsules. The drying process selected is largely determined by the material contained in the capsules.

In the embodiment illustrated in FIG. 1a, the initial coating reagent, polycation 1, is transported into the coating reactor BR by opening the valve V3, V23, and V26, and by pumping via the pump P2 from the supply vessel PK1. After reaching an appropriate level in BR, V3 and V23 is closed and V24 is opened, by which the solution is circulated in the cycle. After the formed gel particles have spent a few minutes in the coating bath, the solution is pumped back to PK1 by closing V26 and opening V25 and V4. Afterwards, by closing V4, V24, and V25 and by opening V1, V23, and V26, the globules are washed with DI water, which similar to the precipitation reagent, is first put into circulation through a similar valve position and then is pumped once again by closing V1, V23, and V26 and by opening V2, V24, and V26. By switching the corresponding valves, the reactor BR is then rinsed with the detergent solution from the reservoir tank E in a similar cycle, and afterwards with the first polyanion from container PA1, after which 2-3 washing steps follow. Afterwards, the reactor form the vessel PK2 is supplied with the second polycationic solution, which is then pumped back again towards it. This process sequence is repeated in the same manner with the corresponding reagents from the reservoirs PA2 (second polyanion) or PA3 (third polyanion) until the desired membrane has been built. Afterwards, the membrane capsules are rinsed by opening the ball valves KH2 from the reactor.

In the embodiment according to the invention illustrated in FIG. 3a, this procedural step takes place similarly to that in 1a, although here, the coating takes place in the same vessel R as the shaping. In 3a, V17 and V18 correspond to V23 and V24 from 1a, while V19 and V20 correspond to V25 and V26 from FIG. 1a respectively.

After coating has been completed, the finished capsules are rinsed by opening the ball valve KH from the reactor.

In the variant illustrated in the FIG. 1b, thanks to the existence of two pumps (P3 and P4), the coating reagents may always be pumped back anew from the reservoirs to the reactor BR and back during the entire procedural step when the valves are in the appropriate position. Since in this manner, the coating baths in the BR are constantly renewed in this manner, the concentration of active ingredient in the reactor remains almost constant during this entire initial procedural step. For instance, in order to provide the reactor BR with the cationic reagent PK1, the valve V1 and V2 is opened and V15, 17, and V16 are correspondingly switched. The pump P4 pushes the liquid into the reactor P3 and guides it back to the reservoir. The liquid level in BR is set by controlling two pumps appropriately. By opening and closing the respective valves in the corresponding sequence, the coating reactor is also coated here with the coating reagents from E (detergent), PA1 (polyanion 1), PK2 (polycation 2), etc. The capsules are rinsed out by opening KH2 after coating is completed.

The embodiment variants illustrated in FIG. 2a and FIG. 2b do not work with ready-made solutions but with concentrates that must first be diluted. For this purpose, before the start of the first coating process via the valve V7, the filter F, and the valve V10 (FIG. 2a) or V9 (FIG. 2b), DI water is fed into the reaction vessel R by means of the pump P2 (FIG. 2a) or P3 (FIG. 2b) via the mixing chamber MK and the heat exchanger WT2. At an appropriate level, V7 is closed and V9 (FIG. 2a) or V8 (FIG. 2b) is opened so that the water is circulated in the cycle. Afterwards, via V1, the quantity corresponding to the desired end concentration is added from PK1 to polycation 1—concentrate and the solution is put into circulation. At the end of the dwell time in the first coating solution, V9 (FIG. 2a) or V8 (FIG. 2b) is opened and V10 (FIG. 2a) or V9 (FIG. 2b) is switched, and the solution is discarded. Afterwards, the reactor BR is filled again (sic) with water via V7 and the detergent from vessel E and subsequently discarded. The rinsing of the globules takes place in the same manner with the other coating solutions, in which the concentrates from PA1 (polyanion 1), PK2 (polycation 2), etc., are added. The capsules are rinsed out by opening KH2 after coating is completed.

In the variant according to the invention illustrated in FIG. 3b, the coating process runs analogously to the embodiments cited in FIGS. 2a and 2b. The difference lies in that coating takes place in the same vessel R in which the conversion of the suspension into droplets (shaping) previously took place. V4, VS, V6, V7 from FIG. 2a correspond here to valves V5, V6, V7, and V8.

Patent Claims

1. A method for producing micromembrane capsules chemical substances, proteins, living cells, and/or microorganisms on a large scale, characterized in that the material to be encapsulated is transported into a reactor in a form dissolved in a basic material or a suspended form from a reservoir where drops are generated and through whose precipitation balls are formed, with the balls enclosing the material and which, on their part, are subsequently coated in the same and/or in another vessel through repeated washing around.

2. The method according to claim 1 characterized by several or all of the following steps, which may also be repeated several times:
dissolving or suspending in a basic material the material to be encapsulated
forming this basic material suspension or solution into drops
precipitating the drops
rinsing and suspending in a scouring solution the globules arising from the precipitation
washing around of the globules with a polycationic polymer solution and developing a cationic load on the ball surface
washing the globules with a scouring solution
washing the globules with a detergent solution
washing around of the globules with a polyanionic polymer solution and developing an anionic load on the ball surface
rinsing and suspending in a scouring solution the globules arising from the precipitation
drying the globules

3. The method according to claims 1 and 2, characterized in that the basic material is a soluble natural substance or synthetic.

4. The method according to claim 3, characterized in that the basic material is a ceramic or a wax.

5. The method according to one of claims 1 to 4, characterized in that the basic material is transported to a device for generating drops via a mechanical expedient, preferably a conveyor worm or a pump.

6. The method according to one of claims 1 to 5, characterized in that the basic material is pneumatically transported to a device for generating drops.

7. The method according to one of claims 1 to 6, characterized in that the device for forming drops is a part of a reaction vessel.

8. The method according to one of claims 1 to 7, characterized in that drops are formed from the basic material through vibration, through an airflow, through a rotational movement (centrifugal forces) and/or through emulsification.

9. The method according to one of claims 1 to 8, characterized in that the drops are precipitated chemically, e.g., through the influence of salts.

10. The method according to one of claims 1 to 8, characterized in that the drops are precipitated physically, e.g., through a change in temperature.

11. The method according to one of claims 1 to 10, characterized in that the drops precipitated contain the material to be immobilized.

12. The method according to one of claims 1 to 11, characterized in that the drops precipitated are kept in suspense in the precipitation bath.

13. The method according to one of claims 1 to 11, characterized in that the drops precipitated are kept in suspense in the precipitation bath by stirring.

14. The method according to one of claims 1 to 11, characterized in that the drops precipitated are kept suspended in the precipitation bath through the flow speed of the surrounding medium.

15. The method according to one of claims 1 to 14, characterized in that the drops precipitated are coating by washing out with suitable polymer solutions.

16. The method according to one of claims 1 to 15, characterized in that the drops precipitated are kept suspended during the coating.

17. The method according to claim 16, characterized in that the drops precipitated are kept suspended during the coating by stirring.

18. The method according to claim 16, characterized in that the drops precipitated are kept suspended during the coating by the flow speed of the surrounding medium.

19. The method according to one of claims 1 to 18, characterized in that the coated globules exhibit a cover, which completely surrounds the core, and consequently, the encapsulated material.

20. The method according to claim 19, characterized in that the cover of the coated globules consist of one or more radially arranged layers.

21. The method according to claim 20, characterized in that the layers of the cover may be areas with varying thicknesses.

22. The method according to one of claims 1 to 21, characterized in that the coated globules are used and stored undried, i.e., moist.

23. The method according to one of claims 1 to 21, characterized in that the coated globules are freeze-dried.

24. The method according to claims 1 to 21, characterized in that the coated globules are air-dried.

25. The method according to one of claims 1 to 24, characterized in that the solutions used for the precipitation and/or coating are used either as concentrate or ready for use in diluted form.

26. A facility for carrying out the method according to one of the previous claims, characterized in that it exhibits at least the following main components:
reservoir for the basic material and the material to be immobilized (GS)
reservoir for the precipitation bath (FB)
reservoir for a washing solution, preferably detergent (E)
reservoir for the coating polymers (PK1, PK2, PA1, PA2, PA3)
reactor for the conversion into drops and precipitation of the basic material solution or suspension (FR, R)
reactor for the coating of the precipitated globules (BR, R)
device for drying the coated globules
heat exchanger for tempering the reactors (WT1, WT2, WT)
pumps (P1, P2, P) and valves (V1, V2, . . . ) for filling and emptying the reactors, as well as ball valves (KH1, KH2, KH) and a mixing chamber (MK) .

27. The facility according to claim 26, characterized in that its components are arranged according to FIG. 1a and/or with one another.

28. The facility according to claim 26, characterized in that its components are arranged according to FIG. 1b and/or with one another.

29. The facility according to claim 26, characterized in that its components are arranged according to FIG. 2a and/or with one another.

30. The facility according to claim 26, characterized in that its components are arranged according to FIG. 2b and/or with one another.

31. The facility according to claim 26, characterized in that its components are arranged according to FIG. 3a and/or with one another.

32. The facility according to claim 26, characterized in that its components are arranged according to FIG. 3b and/or with one another.
